(19) United States
(12) Patent Application Publication
(10) Pub. No.: US 2023/0095929 A1
(43) Pub. Date: Mar. 30, 2023

(54) PARENT-EDUCATOR COMMUNICATION PLATFORM

(71) Applicant: Watch Them Learn Inc., Montreal (CA)

(72) Inventor: Maria Milonas, Laval (CA)

(21) Appl. No.: 17/950,736

(22) Filed: Sep. 22, 2022

Related U.S. Application Data
(63) Continuation-in-part of application No. 17/489,050, filed on Sep. 29, 2021, now abandoned.

(51) Int. Cl. G06Q 50/20; G06Q 10/08; G06Q 30/06

(52) U.S. Cl. CPC G06Q 50/205; G06Q 10/083; G06Q 30/0627

(57) ABSTRACT

The present disclosure provides a method and system for providing continuity of learning for early-age learners using a digital platform providing communication between educators and parents. The method comprises providing an educator interface; providing a parent interface; selecting a school activity completed in school using the educator interface; presenting said school activity completed to parents using the parent interface; presenting a media listing associated with said school activity completed to parents using the parent interface; viewing at least one item from said media listing using the parent interface; receiving, using the parent interface, input representing learning appreciation regarding said at least one item viewed using the parent interface; and displaying a result of said input representing learning appreciation using the educator interface.

This patent application is a continuation-in-part of U.S. patent application Ser. No. 17/489,050 filed on Sep. 29, 2021.

### TECHNICAL FIELD

The present patent application relates generally to the field of educational technology and systems, for example platforms used for education of students.

### BACKGROUND

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the description and claims in this application and is not admitted to be prior art by inclusion in this section.

E-learning is becoming more and more popular. E-learning may either be synchronous or asynchronous. Synchronous learning occurs in real time, with all participants interacting at the same time, while asynchronous learning is self-paced and allows participants to engage in the exchange of ideas or information without the dependency of other participants ‘involvement at the same time.

One example of and one of the most popular types of e-learning is hybrid learning. Hybrid learning or blended learning is a type of e-learning which refers to approaches in which traditional classroom time is reduced but not eliminated and is replaced with some online learning.

Additionally, many educators, in order to make the classrooms and education more interactive, even for traditional classroom settings, use electrical modules and activities as complementary/homework component to improve the quality of education. This is even more popular for early-age learners which includes kindergarten students and generally children prior to their entry into elementary school.

One aspect of learning that Is particularly important for early-age learners is continuity of the education from school to home and vice versa. Early-age learners are always learning. It is important for them to revisit knowledge learned in class at home for reconsolidating knowledge, and also to expand upon what was learned in class, such as through videos on related subjects. It is also important for the early-age learner to feel as though what they learn in school is still important outside of school. For example, learning about the solar system in class may readily be forgotten if the early-age learner doesn't revisit the information at home. Perhaps the early-age learner may even watch a video with parents about astronauts and develop a new interest. It may also be beneficial for an educator to know which students have deepened or broadened their knowledge of a subject outside of class, or know which students enjoyed which activities.

Despite being beneficial, many forms of hybrid learning result in discontinuity in educational activity of students, especially early age students, as the parents and educators do not receive feedback from each other regarding each activity performed by the students and activities are typically performed and designed in a vacuum from each other.

Therefore, there exist a need for a system that provides continuity for the learning activity performed in e-learning setting, specifically hybrid learning mode.

Moreover, as children normally spend several hours during the day at daycares and away from parents, it is very important and interesting for parents to receive reports and news about activities students attended during the day. Traditionally this would be done by asking the teacher for a report and possibly photos of the students. This in additional to be burdensome for the teacher is typically not practical as in lager class set it would be impossible to teachers to keep track of each of the students and to provide media reports of the activities performed. Additionally, in many instances, the parents of early-age learner students would prefer to have a media report (including photos, videos and audio recording) of children's activities throughout a semester or learning period.

Therefore, there also exists a need for a solution to facilitate delivering media reporting of the children during different activities when away from the home. SUMMARY

The present disclosure provides, among others, solutions addressing the above-mentioned problems with the existing shielding materials. This patent application provides complementary improvements that may be applied separately or in combination.

In one broad aspect, the present disclosure provides a method for providing continuity of learning for early-age learners using a digital platform providing communication between educators and parents. The method comprises providing an educator interface; providing a parent interface; selecting a school activity completed in school using the educator interface; presenting the school activity completed to parents using the parent interface; presenting a media listing associated with the school activity completed to parents using the parent interface or presenting an activity or product listing associated with said school activity completed to parents using the parent interface; viewing at least one item from the media listing using the parent interface or acquiring at least one item from said activity or product listing using the parent interface for use with an early age learner with a parent; receiving, using the parent interface, input representing learning appreciation regarding the at least one item viewed using the parent interface; and displaying a result of the input representing learning appreciation using the educator interface.

It would be appreciated by those skilled in the art that early-age learners may include younger students, students requiring assistant with the learning activities or any other types of students even including adult students needing more intense supervision due to the nature of learning activity such as a new language.

It will be appreciated by those skilled in the art that parent interface may include a separate part that could be used by the student with limited access to all information.

In some examples, the method may further comprise providing a new learning activity based on the input representing the learning appreciation, wherein the new learning activity provides learning continuity for the students.

In some examples, the receiving input representing learning appreciation regarding the at least one item viewed using the parent interface comprises collecting key performance indicators (KPI) of the input on the at least one item viewed using the parent interface.

In one embodiment, the presenting the media listing associated with the school activity completed to parents using the parent interface, comprises providing the KPI on the educator interface and receiving the media listing corresponding to the KPI from a user. In some other examples, it may comprise selecting the media listing corresponding to the KPI from a number of predefined media activities.

In some examples of the method, the collecting key performance indicators (KPI) of the input on the at least one item viewed using the parent interface comprises tracking performance of each one of the early-age learners and providing a report on progress of the each one of the students.

It will be appreciated by those skilled in the art that learning appreciation may include quantitative information regarding the participation of students, qualitative information on the performance of information or the students and parents' feedback, or a combination of both. Alternatively, a user may be able to define the learning appreciation of key performance indicators and has the system collects information accordingly. This may include the performance, length of participation, score of participants, feedback provided by the participants or their parents, total number of clicks and/or participation, number of repeats uses, etc.

In some examples of the method, the providing a report on progress of the each one of the students may further include providing a report on progress of the each one of the students on the parental interface. In one embodiment, this may also include providing a progress trend throughout a specific learning period and analysis of the topic in which each individual has better performance.

In some examples of the method, the presenting the media listing associated with the school activity may include receiving the media listing from the educator platform. In one embodiment, this may include the use connecting to different social media platforms or website and embedding specific links in the last to direct the student to that specific platform upon choosing that link.

For example, the list may have a number of videos and/or links from YouTube™, Instagram™ or other educational or public websites. In some examples, the method includes learning appreciation indicator such as KPI on qualitative, quantitative performance of the students from a social media platform or another website.

In some embodiments, the method comprises collecting photos, videos or audio recording of the early-age learners corresponding to the school activity completed. It would be appreciated by those skilled in the art that this collection may be during the at home activities or during class activities performed by the students. In one example the method may include the providing of the photos or videos on the parental interface and receiving feedback on the photos and videos. In one embodiment, the feedback may be used to prepare a compilation of the photos and videos by the system or an administrator which could be offered to parents.

In some embodiments, the presenting comprises presenting the activity or product listing. In one embodiment, acquiring at least one item from the listing using the parent interface comprises specifying delivery of at least one item to a school location associated with the educators.

In one broad aspect, the present disclosure provides a system for providing continuity of learning for students. The system comprises an educator module; one or more student module and a control module. The control module comprises a processor; and a non-transitory computer-readable medium containing instruction that, when executed by the processor, causes the processor to perform; receiving from the educator module, a learning activity or objective for the students; providing the students with the one or more associated activities on the one or more student module; collecting key performance indicators (KPIs) on participation and performance of the students in the one or more associated activities; and providing a new learning activity based on the KPI, wherein the new learning activity provides learning continuity for the students.

A system for providing continuity of learning for early-age learners using a digital platform providing communication between educators and parents students and providing continuity of learning for early-age learners using a digital platform providing communication between educators and parents. The system comprises at least one processor; at least one non-transitory computer-readable medium containing instructions that, when executed by the processor, cause the at least one processor to perform; providing an educator interface; providing a parent interface; selecting a school activity completed in school using the educator interface; presenting said school activity completed to parents using the parent interface; presenting a media listing associated with said school activity completed to parents using the parent interface or presenting an activity or product listing associated with said school activity completed to parents using the parent interface; viewing at least one item from said media listing using the parent interface or acquiring at least one item from said activity or product listing using the parent interface for use with an early age learner with a parent; receiving, using the parent interface, input representing learning appreciation regarding said at least one item; and displaying a result of said input representing learning appreciation using the educator interface. In some embodiments, the presenting comprises presenting the activity or product listing. In some embodiments, acquiring at least one item from the listing is done by using the parent interface comprises specifying delivery of at least one item to a school location associated with said educators. In some embodiments, receiving input representing learning appreciation regarding at least one item viewed using the parent interface comprises collecting key performance indicators (KPI) of the input on said at least one item viewed using the parent interface.

In some examples, the system may further comprise a parental module and the non-transitory computer-readable medium further contain instructions that cause the processor to perform; collecting feedback on the one or more associated activities by the parental module of the platform. In one example, the system is operative as a cloud-based service to communicate with the educator module and student modules over a computer network. In one embodiment of the system, the providing the new learning activity based on the KPIs, may comprise reporting the KPIs on the educator interface; and receiving the new activity corresponding to the KPIs from a user.

In another example of the present system, the receiving the new activity corresponding to the KPI from the user comprises suggesting a list of activities to the user.

In one embodiment, the providing the new learning activity based on the KPI, comprises selecting the new activity corresponding to the KPI from a number of predefined new learning activities. In some examples, the collecting KPI on participation and performance of the students in the one or more associated activities comprises tracking the performance of each one of the students and providing a report on progress of the each one of the students. In one embodiment, the providing the students with the one or more associated activities on the student interface of the platform comprises receiving the one or more activities from the educator platform.

In some embodiments of the present system, the providing the students with the one or more associated activities on the one or more student module comprises providing a list of predefined learning activities related to the one to the user to select the learning activity or objective to choose.

In one example, the non-transitory computer-readable medium further contains instructions that cause the processor to perform: collecting media from the student platform. In some embodiments, the collecting media comprises collecting media corresponding to one of the one or more associated activities, the learning activity or objective and the new activity. In another example, the collecting media corresponding to one of the one or more associated activities, the learning activity or objective and the new activity comprises collecting multimedia.

In one broad aspect the present disclosure provides a method for providing photo compilation on students' activities using a platform. The method comprises receiving by an educator module of the platform a number of photos of the students' activities; using an administrator module of the platform to select a number of photos and a desired arrangement of the number of photos related to a time period and/or an activity to be memorialized and to identify a compilation name; generating a photo compilation; presenting the photo compilation for purchase on a parent module of the platform. In some examples, the method may further comprise providing the photos by the parental module of the platform for review; and collecting key performance indicators (KPI) on the photos using the parental module and reporting the KPI to the administrator module.

In some examples of the method, the using the administrator module of the platform to select the number of photos and the desired arrangement of the number of photos related to a time period and/or an activity to be memorialized and to identify the compilation name comprises using the KPI to select the number of photos and the desired arrangement. In one example, the method may further comprise using a face recognition module of the platform to determine identity of students present in each one of the numbers of photos, and wherein the generating the photo compilation comprises generating compilation for each one of the students based on the identity determination. In some other examples of the method, the generating a photo compilation comprises receiving identity of each one of the students participating in the each one of the activities from the administrator module.

In some embodiments, the present method may include using the KPI and wherein the at least one of the factors to provide the selection of photos comprises providing the number of photos based on the KPIs; and allowing a user to selecting the selection of photos.

In one other broad aspect, the present disclosure provides a system for providing media report on students' activities. The system comprising an educator module having an educator interface; a parental module having a parental interface; a control module comprising: a processor; and non-transitory computer-readable medium containing instruction that, when executed by the processor, causes the processor to perform: receiving by the educator module photos related to a number of activities and information regarding each one of the numbers of activities comprising one or more of type or learning objective; date and location, list of participants; providing the media by a parental interface for parents' review; collecting key performance indicators (KPI) on the media using the parental module and reporting the KPI to the educator module; and using the KPI and at least one of the types or learning objectives, the date and location, the list of participants, to provide a selection from the media for at least one of the students.

### BRIEF DESCRIPTION OF THE DRAWINGS

The invention will be better understood by way of the following detailed description of embodiments of the invention with reference to the appended drawings, in which:

FIG. 1 shows a schematic view of the system providing educational continuity as disclosed herein in accordance with one embodiment of the present disclosure.

FIG. 2(a) shows a schematic view of the system disclosed in accordance with one embodiment of the present disclosure providing continuity between educators and parent learning activities.

FIG. 2(b) shows a schematic view of the system disclosed in accordance with one embodiment of the present disclosure having an activity purchase option.

FIG. 2(c) is a flowchart of the system shown in FIG. 2(a) in accordance with one embodiment of the present disclosure.

FIG. 2(d) is a flowchart of how the interface may provide feedback about parental and child engagement to the educator in one embodiment of the current disclosure.

FIG. 2(e) illustrates schematically the display of a dashboard for the educator interface.

FIG. 3(a) shows a schematic view of a system disclosed in accordance with one embodiment of the present disclosure providing photo compilation on students' activities.

FIG. 3(b) is a flowchart of the system shown in FIG. 8(a) in accordance with one embodiment of the present disclosure.

FIG. 4 shows a schematic view of the system in accordance with one embodiment of the present disclosure with exemplary details of the private network and content delivery network.

FIG. 5 shows a screenshot of the app used by the present system showing video title of a learning activity in accordance with one embodiment.

FIG. 6 shows a screenshot of the app used by the present system showing test comments page in accordance with one embodiment.

FIG. 7 shows a screenshot of the app used by the present system showing image comments page in accordance with one embodiment.

FIG. 8A shows an example of a cover of a book forming part of an educational activity item.

FIG. 8B illustrates a felt board on which a child can place felt planets and other objects during the educational activity.

FIG. 8C illustrates some felt objects with labels.

FIG. 9 is a data flow diagram for photo album creation in accordance with one embodiment of the present disclosure.

FIG. 10 shows a screenshot of the platform web page for creating an album in accordance with one embodiment of the present disclosure.

FIG. 11 shows a screenshot of the platform web page for choosing an album in accordance with one embodiment of the present disclosure.

FIG. 12 shows a screenshot of the platform web page for choosing photos in accordance with one embodiment of the present disclosure.

FIG. 13 shows a screenshot of the platform web page for entering information of person creating and/or purchasing the album in accordance with one embodiment of the present disclosure.

FIG. 14 shows a screenshot of the platform web page for confirming payment for the album in accordance with one embodiment of the present disclosure.

FIG. 15 shows a screenshot of the platform web page for delivery status of the album in accordance with one embodiment of the present disclosure.

FIG. 16 shows a screenshot of the application page for choosing an album in accordance with one embodiment of the present disclosure.

FIG. 17 shows a screenshot of the application page for choosing photos in accordance with one embodiment of the present disclosure.

FIG. 18 shows a screenshot of the application page for entering information of person creating and/or purchasing the album in accordance with one embodiment of the present disclosure.

FIG. 19 shows a screenshot of the application page for confirming payment for the album in accordance with one embodiment of the present disclosure.

FIG. 20 shows a screenshot of the application page for delivery status of the album in accordance with one embodiment of the present disclosure.

### DETAILED DESCRIPTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the scope of the invention. Thus, it is intended that the present invention cover the modifications and variations of this invention provided they come within the scope of the appended claims and their equivalents. Reference will now be made in detail to the preferred embodiments of the invention.

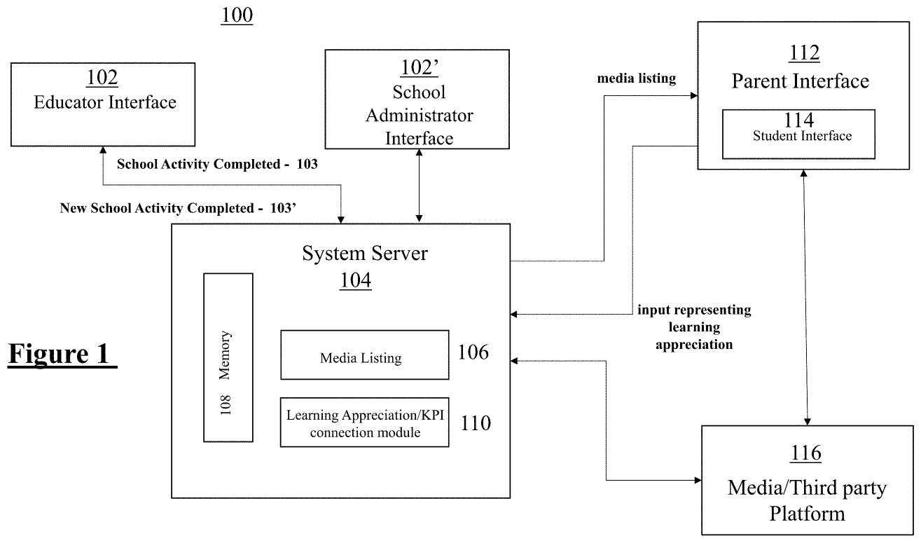

Referring to FIG. 1, in one example, the present disclosure provides a system 100 having an educator interface 102 which receives a school task/activity 103 completed by the student or early-age learners the class. The class activity 103 may be done through a remote class setting or in person setting. It may also be an activity such as a park, zoo, factory site visit, visit of a museum, theater, etc.

It will be appreciated that the term early-age learners and student may be used throughout this application interchangeably and may refer students at any age group which need a higher level of interaction or supervision from the educator. It would also be appreciated by those skilled in the art that early-age learners may include younger students, students requiring assistant with the learning activities or any other types of students even including adult students needing more intense supervision due to the nature of learning activity such as a new language.

In some examples, the activity may be defined by an educator using the educator 102 or alternatively be pre-defined as a part of the curriculum. System server 104 may receive the school activity and based on the activity 102 provides a media listing 106 which is relevant to the activity 103.

In addition to or within the functionality of the educator interface 102, a school administrator interface 102′ may be provided. The administrator interface is configured to provide an administrator of a school with the ability to monitor school activities completed 103 and to either monitor or to define future school activities, for example in accordance with a syllabus or curriculum.

In some examples, the media listing 106 may be defined by the educator through educator interface 102. Alternatively, the system may assign media listing 106 based on last information stored in memory 108. The information stored in memory 108 may be related to the previously completed tasks by the class or an individual student and their performance or interest. The media listing 106 may be presented on parental interface 112 for the students to follow the activities at home.

It will be appreciated by those skilled in the art that the media listing may include a list of media links/third party platform 116 which may include links to educational websites providing learning modules, to multimedia platform or a specific activity design and/or suggested by the educator through interface 102.

In some examples, the media listing 106 may be the same for all students. Alternatively, the media listing 106 may be defined for each one of the students individually and based on the educator discretion and/or previously recorded information system has on each student.

In some examples, the parent interface 112 may include multiple layers including private chats between parents and educators, information on student performance or interest, etc. which may not be accessed by the students. Therefore, in one embodiment, the parent interface 112 may have a student interface 114 as separate sublayer of the parent interface which can be accessed by the students to provide the media listing.

In one example, not shown in FIG. 1, the student interface 114 may be completely separate interface from parent interface 112. In one other example, the student interface may replace parent interface 112.

It should be understood that one preferred embodiment does not have a student interface 114. Early-age learners (such as extremely young children) often do not have the capacity to manage a student interface or manage their own education, and often will not yet have responsibilities associated with independent students (such as homework, quizzes, managing grades, etc.). The primary focus of the current disclosure is the continuity of education of the early-age learner, and this is primarily done via communications between a parent interface 112 and an educator interface 102 of the content that the early-age learner is being exposed to, inside and out of school.

In one embodiment, the system 100 may use learning appreciation/key performance indicator module 110 to collect input on the media listing 106 from the parent interface 112. This may represent learning appreciation of students about one or more of the activities on the listing 106. In some examples, this input may be in form of feedback received from parents or students via parent interface 112 or student interface 114. Equally, the input may be based on more data driven information KPIs measuring information about the parents' or students' interest in activities provided in media listing 106.

For example, if the media listing 106 has a survey to complete by the students asking the students whether they enjoyed the media listing or learned anything new, the results of the survey of students may be used as input for learning appreciation.

In some embodiments, the system may collect key performance indicators (KPIs) which may be defined by the educator using educator interface 102. Some examples of KPIs may include reports on the number of views for each item in the listing, duration of viewing/participation for each activity, the number of likes each activity received from students and/or their parents.

In some examples, the learning appreciation and/or KPIs may be used by the educator to generate media listing 106 for subsequent activities. For example, if an educator notices that a large proportion of the students watched videos about astronauts after learning about the solar system, the educator may add a new media listing on the topic of a certain group of astronauts, or the history of space travel. In another example, the learning appreciation and/or KPIs collected may be used by the system 100 to generate the media listing 106 automatically or from a predefined list of activities or media links. For example, if a large proportion of students watched a video about astronauts, the system may recommend another video on a similar topic or a product of a learning activity on the theme of astronauts.

In one example, the learning appreciation and/or KPIs may be used to define a new school/learning activity 103. For example, if an educator notices that a large proportion of the students watched videos about astronauts after learning about the solar system, the educator may spend a class talking about astronauts, or the moon landing. Or, the educator may ask the class to tell them about astronauts, thus allowing the early-age learners to take a proactive role in their own continuous learning.

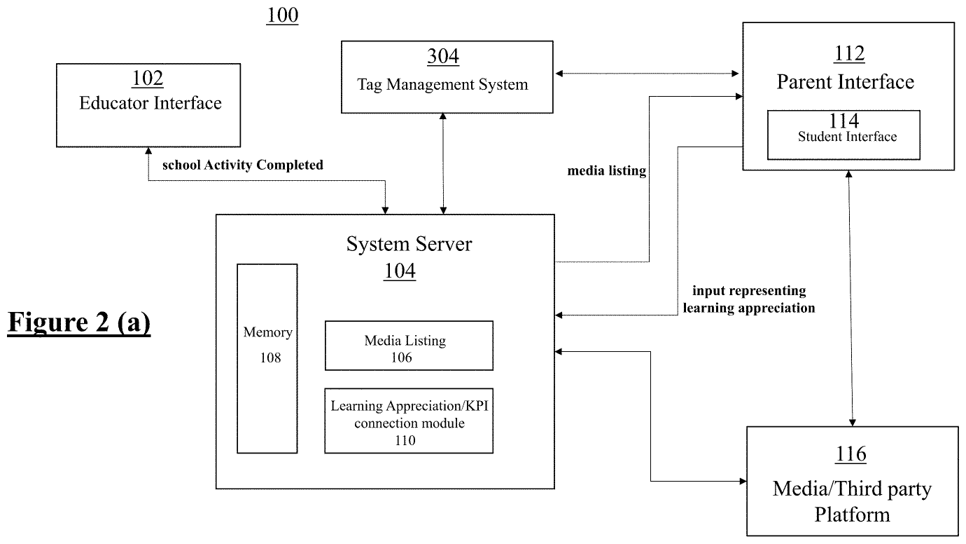

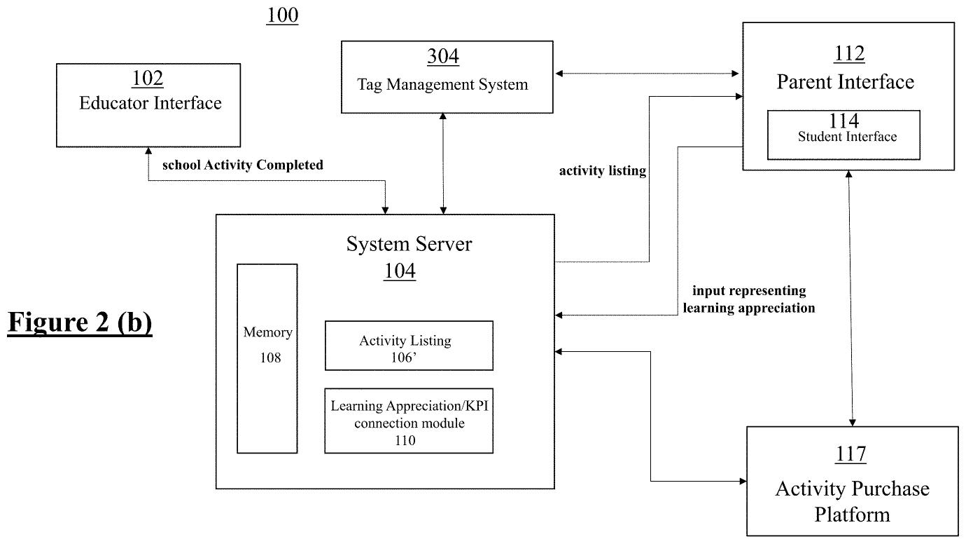

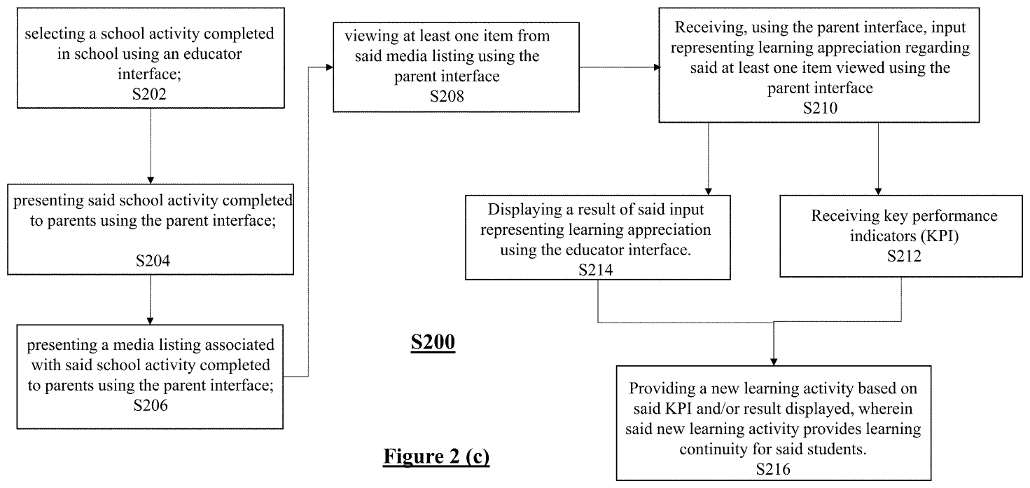

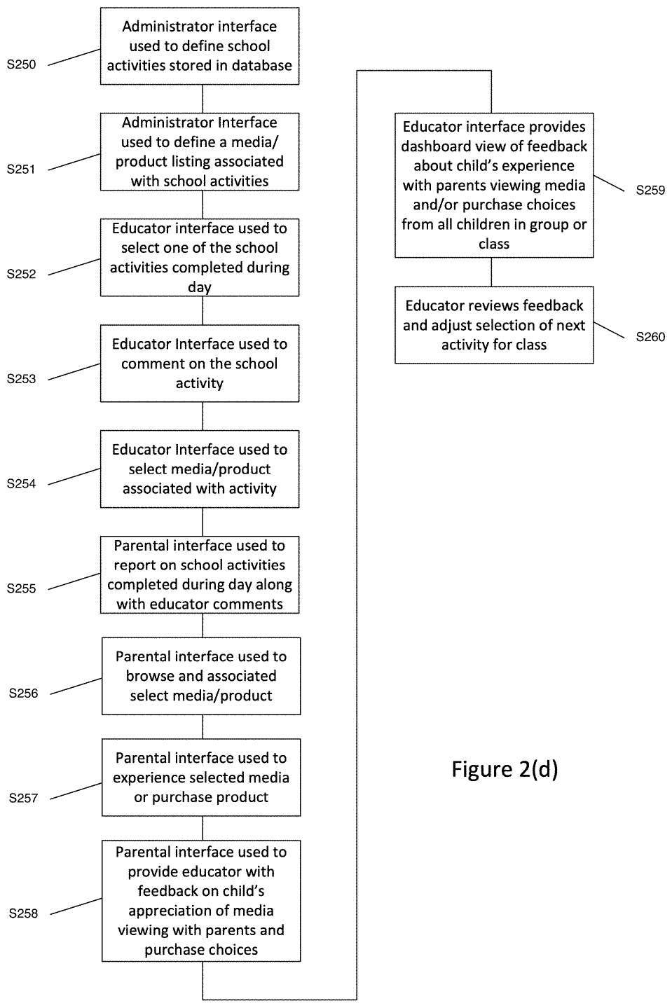

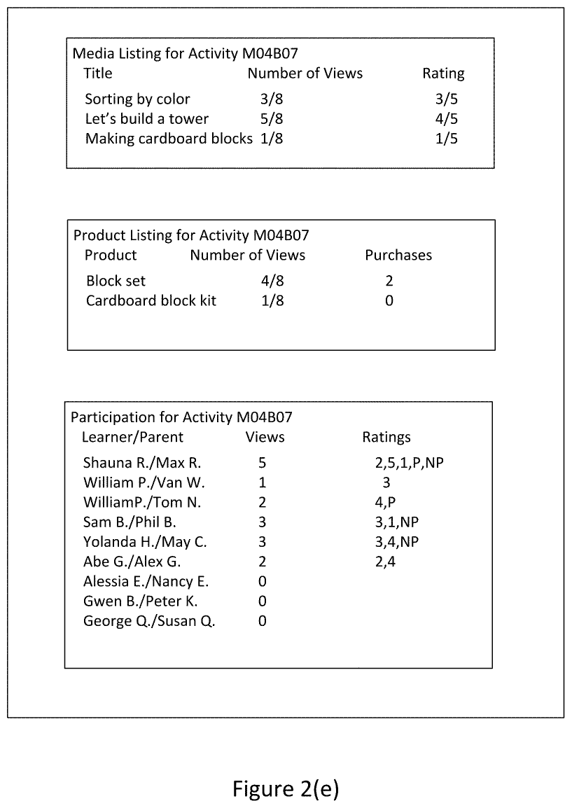

As shown in FIG. 2(a), in some embodiments of the present system, a management system 304 may be used in order to collect the KPIs or learning appreciation on each one of the links provided in media listing 106.

While in the embodiment of FIG. 2(a), the media listing 120 is the object provided to the parent interface 112 based on the school activity input using the educator interface 102, in some embodiments, the listing data 120 can comprise a listing of activities and/or products, whether exclusively or including a media listing, as shown in FIG. 2(b). An activity listing store 106′ can store a list of activities or products that are associated with school activities or topics. In the case of an educational activity or product to be purchased, the parent interface may be connected to a purchase platform 117.

In the case of educational lessons, activities or experiments, children can learn with parents at home through play. An example activity is “Exploring the solar system” that is a boxed item including a book about the solar system which teaches the child about the planets etc., along with a felt board with all the planets, stars, spaceship and so much more. This opens the child's imagination in a fun and interactive way. An essential part of a child's learning is to actually do and practice the activity, and this can be accomplished by providing an educational activity in this way. Online learning platforms today, though learning from home is made possible, leave out this essential part and thus children are simply left staring at a screen without exercising their skills and developing.

While optional, activities or products purchased from platform 117 can be delivered to parents through the school. In this case, the administrator interface 102′ (see FIG. 1) can be used to inform the school of the purchase. Preferably, when a number of parents choose to purchase a product or an activity, a combined shipment to the school can be used to reduce shipping cost, and the school administrator can oversee the distribution of the items to the parents.

In other embodiments, a school administrator can pre-purchase activities or products for delivery to the school, and purchase of such items through the parent interface 112 using platform 117 can result in the school administrator receiving a message to provide the item to the parent. This can avoid delivery delay. Parental interest in activities or products, expressed through purchases, can be stored in the module 110 and shared with the administrator through interface 102′ in a way that can be used to inform decisions on future offerings of activities or products.

As illustrated in FIG. 2(c), in one broad aspect, the present disclosure provides a method S200 for providing continuity of learning for early-age learners using the digital platform/system 100 and for providing communication between educators and parents. As shown in FIG. 2(c), the method comprises in step S202 selecting a school activity 103 completed in school using the educator interface 102. Then in step S204, the school activity completed is presented to parents using the parent interface 112 along with, in step S206, presenting the media listing 106 associated with the school activity 103 completed to parents using the parent interface112. Then in step S208, the parent interface 112 is used to view at least one item from the media listing 106 using the parent interface. Then in step S210 the parent interface is used to receive input representing learning appreciation regarding the at least one item viewed using the parent interface 112. At step S214, the results are the displaying a result of the input representing learning appreciation using the educator interface 102. The system may, as indicated in step 212, receive KPIs from the parent interface 112. Lastly, at step S216, the KPI or learning appreciation result may be used by the educator or system to provide a new learning activity based on said KPI and/or result displayed, wherein said new learning activity provides learning continuity for said students.

In one example, if after reviewing the results of the input received from the parent interface 112 at step S216, the educator feels that student needs more work or have interest in certain topics the new learning activity 103′ may be adjusted accordingly.

For example, the list may have a number of videos and/or links from YouTube™, Instagram™ or other educational or public websites and KPI may be collected using tag management system 304. The tag management system 304 may thus collect information about media viewing from external media platforms without using direct input from the parent interface 112, and the resulting KPI can be collected by the module 110. This can be used to improve the quality of data concerning the home-based learning appreciation.

In some examples, the system may include providing a report on progress of the each one of the students. It may also may include providing a report on progress of the each one of the students on the parent interface 112. In one embodiment, this may also include providing a progress trend throughout a specific learning period and analysis of the topic in which each individual has better performance or interest.

In some examples of the method, the presenting the media listing 106 associated with the school activity 103 may include receiving the media listing 106 from the educator platform 102. In one embodiment, this may include the use connecting to different social media platforms or website 116 and embedding specific links in the last to direct the student to that specific platform upon choosing that link.

In some embodiments of the present disclosure, the system 100 comprises the educator module 102; one or more student and/or parent module 112/114 and a control module 104. The control module comprises a processor; and a non-transitory computer-readable medium such as memory 108 containing instruction that, when executed by the processor, causes the processor to perform; receiving from the educator module 102, a learning activity or objective 103 for the students; providing the students with the one or more associated activities or media listing 106 on the one or more student or parent module 112/114; collecting key performance indicators (KPIs) on participation and performance or interest of the students in the one or more associated activities; and providing a new learning activity based on the KPI, wherein the new learning activity 103′.

It will be appreciated by those skilled in the art that the processor and the computer-readable medium may form a part of system server 104 and may have any form known in the art including a local server or cloud server.

FIG. 2(d) is a flowchart of how the interface may provide feedback about parental and child engagement to the educator in one embodiment of the current disclosure. In this embodiment, an administrator interface (for example, the school administrator interface 102′) may be used, such as by an administrator, to define school activities stored in a database of server system (for example, system server 104) S250. The list of activities can be divided by subject, such as math, language, science, art, culture or geography, and within such a subject, the activities can relate to topics or modules of learning. In some cases, the list of activities can correspond to a learning syllabus. The administrator interface may then be used to define a media/product listing (for example, storage 106) associated with school activities S251. Some items of media or products can relate to a number of activities or they can be unique to the topic of the activity. For pre-school learners, video media is best selected to be short in length and visually interesting or entertaining. While the administrator interface can be used to create the listing of media associated with the learning activities, the educator interface may also be used. The task of creating or selecting suitable videos or presentations to be included in the database for continuing learning with parents at home can be as important as what is done in school. The educator interface may then be used, such as by an educator, to select one or more of the school activities completed during the day S252. The educator interface may then be used to comment on the school activity S253, such as to indicate how the children responded to the topic. The educator interface may then be used to select media or products associated with the activity S254, and that selection may be transmitted to the parent interfaces for the parents associated with the learners in the class or group of the educator (see for example, the transmission of the media listing from the server 104 to the parent interface 112 in FIG. 1). In the event that the educator showed a video in class to teach a topic, the educator may choose to omit such a video from the selection of what is recommended to be viewed at home. In some cases, the educator may encourage children to watch a video a second time at home with their parents as a review or to stimulate discussion or interaction with the parents. In addition to video media, the list may include a chapter of a story book that the parents can read to the child, or a section of a reference book that the parent can read to the child. It can also relate to a game or activity to be played with the child. In some cases, a topic in the classroom relates significantly to a product that parents can purchase, such as a toy, craft, book, etc., and the educator can select one or more of the possible products for the parents to consider as a purchase. The educator can then provide a comment as to in what way the product is relevant to what was learned or will be learned in school, or simply how the product may be important to the child's development.

The parental interface may then be used, such as by parents, to report on school activities completed during day along with educator comments S255. This can include feedback on how a child felt about what was done in school with respect to the activity. The parental interface may then be used to browse and select the associated media or products that the educator selected for the class or group S257. The parental interface may then be used to view media with the child (this can also be done outside of the parental interface) and then to provide the educator with feedback on a child's appreciation of media viewing with parents and/or purchase choices S258 (see for example the transmission of input representing learning appreciation from interface 112 to server 104 in FIG. 1). The parental interface may prompt the user to provide feedback about media after the media is viewed and may prompt the user to provide feedback later in the evening without knowing whether the media was viewed or not. The feedback input may be sent to a server where the data from parents in the class or group can be collected (see for example, the learning appreciation/KPI collection module 110). The educator interface may then retrieve from the server and provide a dashboard view of feedback about a child's experience with parents viewing media and/or purchase choices from all children in a group or class S259. The dashboard may provide the educator with an easy to perceive impression of which children and how many children participated in any additional media viewing with parents. The dashboard may provide the educator with an easy to perceive impression of which media were liked by the children and/or which products were purchased by the parents of the children.

An example of the dashboard is schematically illustrated in FIG. 1(e). In the example, the dashboard includes the selection of media and products associated with the activity as made by the educator the previous day. The activity can be identified as illustrated in a way that helps the educator recognize what the activity was, for example, M can stand for math, 04 for four years of age, B for the module concerning building blocks, and 07 for the specific unit. The three media files selected and the two products selected may have been selected by the educator from a list of possible media and products. The dashboard shows the number of views for the media by the eight children in the group or class, along with the average rating given by the parent interface. The product listing likewise may show the number of views of the products and the number of purchases. Views without a purchase may be considered as a non-purchase (NP). The dashboard may also provide a listing of the children with the participation statistics. In the example of FIG. 1(e), there are eight children in the group or class. In the case of William, two parents participated with their child, while for the others, only one parent interface was used. In the example, a ranked listing by participation is provided. In the example, Shauna viewed the three videos and the two products, and a block set was purchased. Alessia, Gwen and George did not use the parental interface that day.

The educator can glean from the dashboard that the video, “Let's build a tower” was the most liked. The educator can then choose whether to show the video in class, recommend it again to the parents so that those three children who missed it can see it for the first time tomorrow, to choose a new topic related to the topic of interest, or whether to choose a new topic because of the lack of interest by three of the children. Thus, the educator may review the feedback provided on the dashboard view, and adjust the selection of a next activity for class S260.

The usefulness of the dashboard merits additional description. As previously mentioned, continuity of education between the in-school environment and out-of-school environment is incredibly important for early age learners. Educators do not often have the ability to know how or whether their students have continued their education outside of school. To do so would require time consuming conversations with parents. Obtaining feedback from pre-school children is challenging if unreliable. Moreover, some children or parents may simply not remember what they had done at home. The interface as provided may assemble a dashboard automatically, which may provide the educator with enough information to know, at a glance, about the continuity of education of their students. For example, if many of the children participated in watching a video, the teacher may choose to spend the beginning of the next class having a class discussion about the video. For example, if one child, who usually does not participate in any activities (in or out of school) engages in one of the media or products presented to the parental interface, the teacher may use the opportunity to learn more about what interested that child about that particular media or product. For example, if a child has engaged with a product, the educator may ask the child to describe the product.

Such a dashboard may present a variety of information. The information may be presented in a non-consolidated manner (i.e., merely show the educator which students engaged with which media or products), or the information may be presented in a consolidated manner (e.g., showing statistics about which media or products were most popular, or which children engaged more or less than they usually do). The dashboard may even flag important events, such as a child who usually does not engage in activities engaging with a media or product, or that a new product received exceptionally positive feedback. Having all of the information available in the dashboard, in a format that can be absorbed at a glance by the educator, would greatly decrease the amount of time needed for an educator to be up to speed on the continuity of a child's education.

Such a dashboard may be public (i.e., viewable from the parental interface) or restricted to educators and administrators (not viewable on the parental interface).

It is also important to note that products or media on the parental interface may also allow parents or children who would not have normally engaged out of school learning to begin to do so. Having a list of media or products would greatly improve the convenience of finding relevant activities, and improve continuity between in and out of school learning.

The responsibilities of adulthood and parenthood demand that parents miss certain milestones during the daycare experience, thus being able to capture these moments through print enables parents to cherish these moments.

In one aspect the present disclosure a Photo Wall apart from the activity feed where the parents see all the posts: Lessons, Photos, Meals, Videos, Nap-Time, Attendance, etc. The Photo wall in the Parent App is created for the purpose of capturing and storing all the child's milestones, periodically monitoring learning progress daily, weekly, etc.

In one aspect, the system disclosed herein provides the possibility to store all pictures in one place, from the first day the Child attends Daycare to present. Educators may update parents through posting pictures in the App for the Parent to observe their child's progress via the Activity section, thus enabling them to track their child's progress.

How the Photo Wall or albums work, for the parents, they will get to compare pictures and statuses from the first day of daycare and throughout the subsequent weeks, months, and year and then provide feedback on the photo by liking them or leaving comments.

Pictures in the Photo wall can be selected by parents or an admin to create a Photo Album. To do so, they will click on the “Create Album” function on the left top corner, where it will lead them to a variety of albums, they will then choose what type of phot Album design they would like, and then choose the photos on the Photo wall to create the album in PDF (Electronically) or Hard cover, which will then be shipped or printed depending on the selection.

The Photo Wall presents an easier and more efficient way of locating photos, rather than going into the activity feed to look for photos taken at an earlier date.

By specifying the month, you would like to see in the search bar, we expedite the process simply and efficiently. Moreover, the Photo Wall provides Parents with all the child's milestones in a Memory Album.

The system provides multiple advantages as parents are not required to upload any images. All the images uploaded by the teachers in the (Photo Wall) are all images from AWS3 (cloud) and our database. The images are directly coming from the Photo Wall images that teachers have taken from the first day the child started Preschool/Daycare. There is no need to download any pictures, something in stark contrast to other photo apps in the contemporary market.

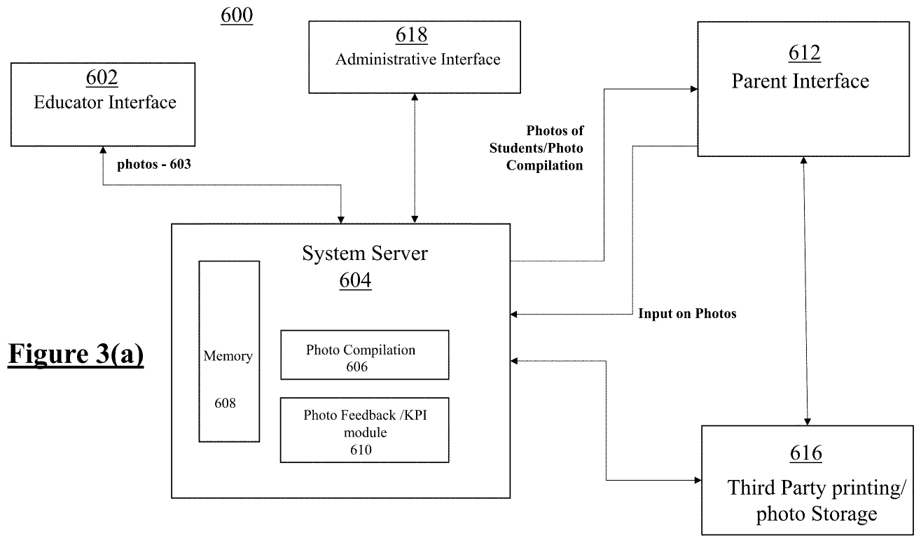

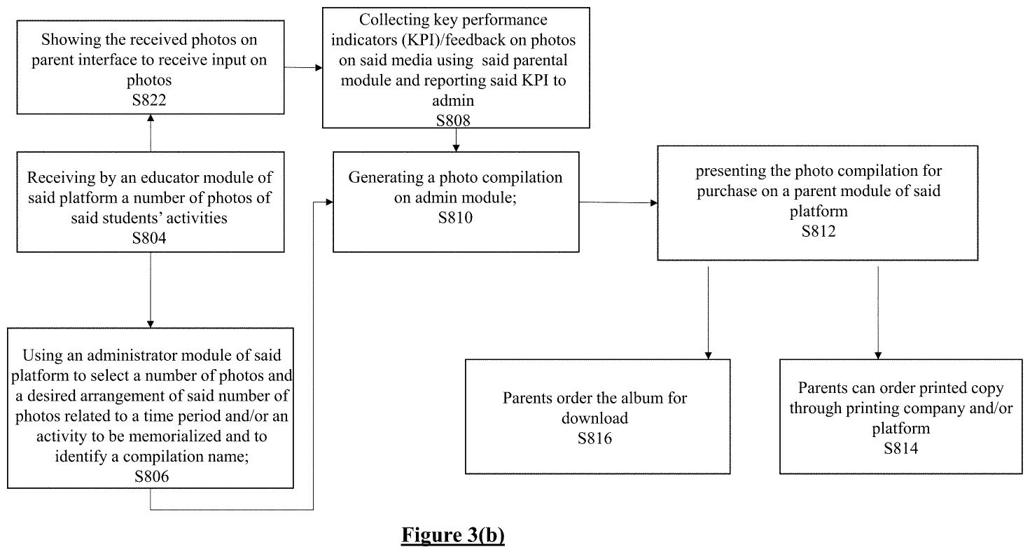

As illustrated in FIG. 3(a), in one aspect, the present disclosure provides a system 600 for providing photo compilation on students' activities. The system includes an educator platform 602 for receiving photos 603 via a system server 604.

In some embodiments, the system server 604 may include a photo compilation module 606, a memory 608 and photo feedback/KPI module 610. The photos 603 received by the server 604 may be associated to different activities and/or different individuals. This may be performed by a user or may be performed automatically. In case of activity, the name of the activity for each date may be received and photos are automatically may be assigned to that specific activity. In terms of individuals, if the names are not entered by a user, the system may use a face recognition service to recognize each individual in the photo and assign them accordingly.

It will be appreciated by those skilled in the art that other forms of media such as video recording, texts, voice recording, etc. can also be received by the system instead of the photos 603.

In some embodiments, an administrative interface 618 may be used to access photo compilation module 606 and to create a compilation of student photos using the administrative module 618. The photo compilation module 606 may also create photo albums and let a user adjust select the desirable photo album using the administrative interface 618.

In some examples, the photos may be presented on a parent interface 612 to receive feedback or input on the photos. A user and/or the photo compilation module 604 may use the feedback received on the photos to create albums with better popularities.

In some embodiments, the album can be presented to parents for purchase. Parents may also download the album or order a printed copy using module 616. The printing and/or storage service may be a third party or an integral part of the system 600.

Referring to FIG. 3(b), shows a method for providing photo compilation on students' activities using the platform 600. The method comprises, at step S804, receiving by an educator module of said platform a number of photos of said students' activities. It is followed at step S806 by using an administrator module 618 of the platform 600 to select a number of photos and a desired arrangement of said number of photos related to a time period and/or an activity to be memorialized and to identify a compilation name. In step S810, a photo compilation may be generated on admin module 618 and in step S812 may be presented for purchase on a parent module 612 of said platform 600. Then parents may order the album for download as in S816 or order printed copy through printing company and/or platform as in step S814.

In some examples, the method may comprise showing the received photos on parent interface 612 to receive input on photos as in S822 and/or collecting key performance indicators (KPI)/feedback on photos on said media using said parental module and reporting the KPI to admin S808. This information may be used by administrators/user or the system to generate a photo compilation on admin module

It would be appreciated by those skilled in the art that this collection may be related to the at-home activities or in class activities performed by the students. In one example the method may include the providing of the photos or videos on the parental interface and receiving feedback on the photos and videos. In one embodiment, the feedback may be used to prepare a compilation of the photos and videos by the system or an administrator which could be offered to parents.

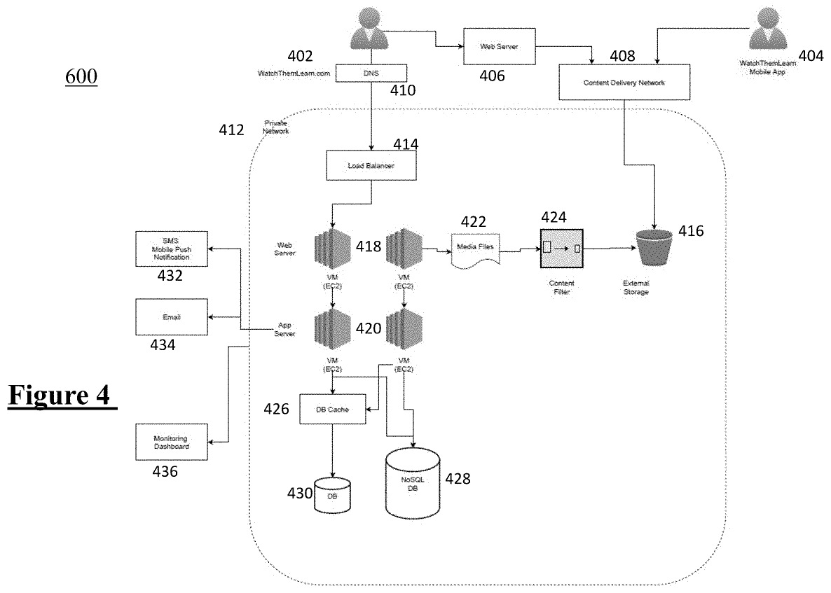

FIG. 4 shows an exemplary structure that may be used by the present system 600. It may include an application 404 communicating with content delivery network 408 which communicate an external storage 416 inside a private network 412.

In some examples, it may also include the web page 402 which may communicate with a Domain Name System (DNS) 410 and content delivery network 408. The DNS 410 may in turn communicate with a load balancer 414 in the private network 412 which may be in communication with web server 418 and app server 420. The web servers 418 get media files 422 and pass them through content filter 424 before storing them in the external storage 416.

The app servers 420 communicate with a database cache 426, NoSQL database 428 and a database 430 and provides information via email 434, SMS mobile push notification 434 and or monitoring dashboard 436.

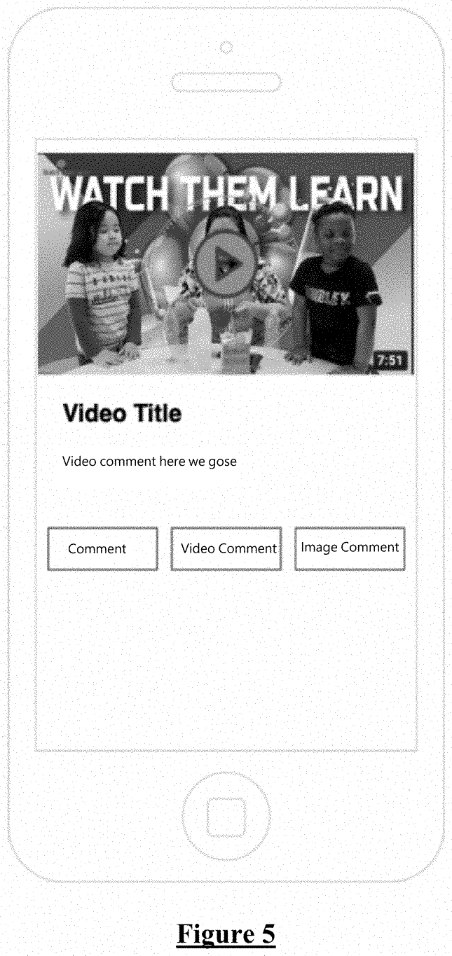

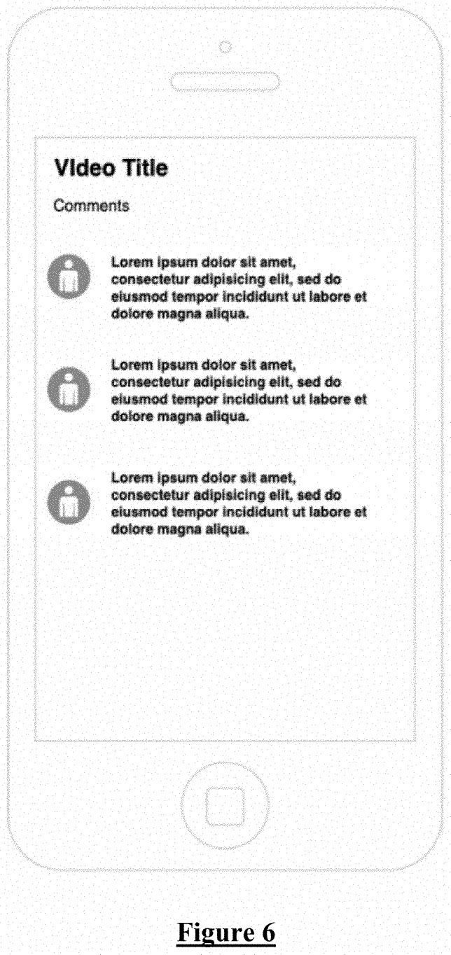

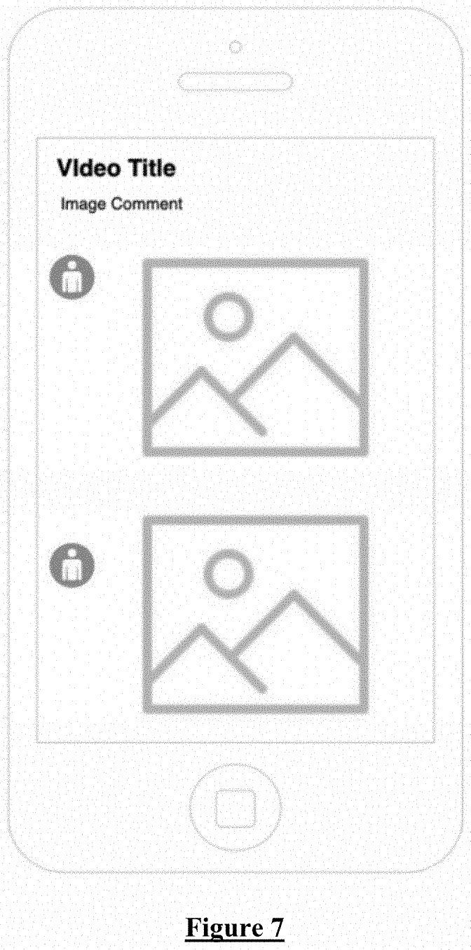

FIG. 5 shows a screenshot of an application used by the system 600 showing a video of students participating in an activity. The parents, students and educators may leave comments, as shown in FIG. 6, on each activity in form of text. Alternatively, as shown in FIG. 7, the comments may be in form of image comment or video comment.

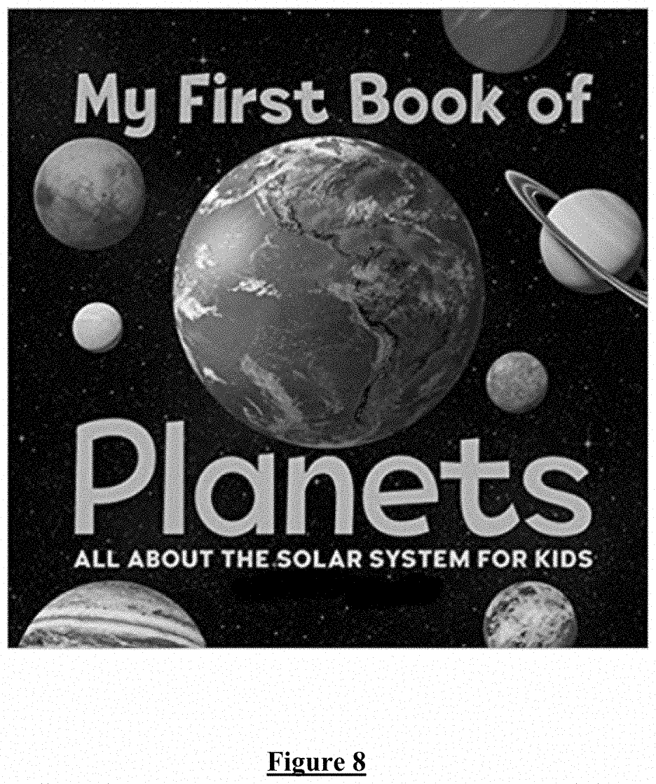

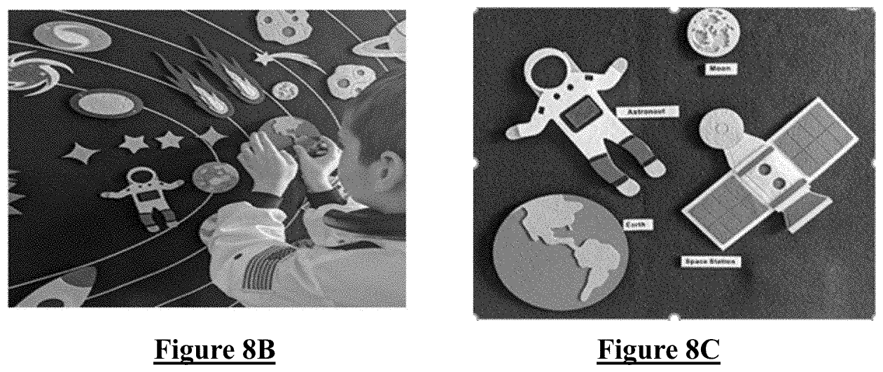

FIG. 8A shows an example of a cover of a book forming part of an educational activity item. FIG. 8B illustrates a felt board on which a child can place felt planets and other objects during the educational activity. FIG. 8C illustrates some felt objects with labels.

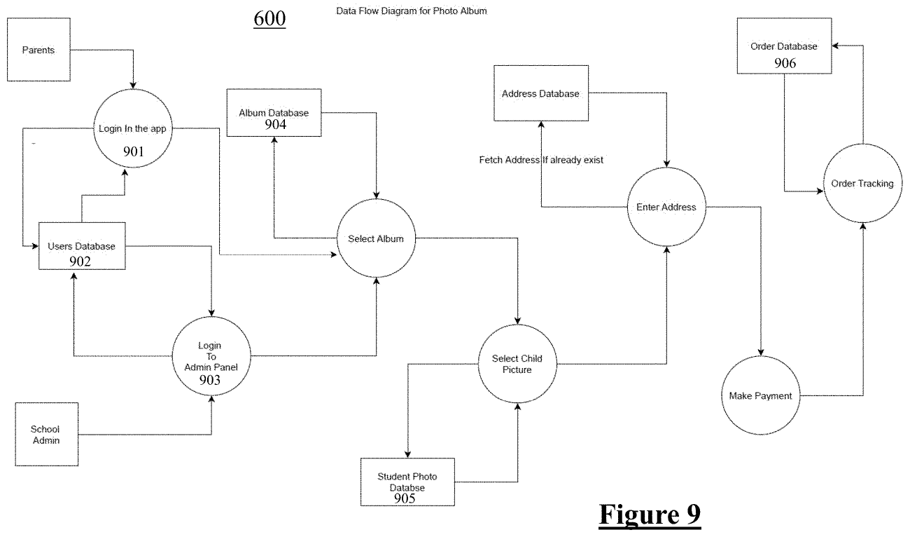

FIG. 9 illustrates a schematic illustration of an embodiment of system 600. As shown parents may log into their app 901 (a part of parent interface 612) which confirms the credentials with a user database 902. Similarly, a school admin can log in using admin panel 903 (a part of administrative interface 618). They may use photo compilation module 606 to create a compilation of photos. In some examples using this module may include selecting an album from album database 904, select a child picture from a student photo database 905. Then the system may receive the address or fetch the address if previously available. It is followed by completing the order of the album/photo by completing the payment. Lastly, the order database 906 may allow the user to track the order delivery and progress.

In one other broad aspect, the present disclosure provides the system 600 may include an educator module having an educator interface; a parental module having a parental interface 612; a control module or system server 604. The control module 604 may comprise a processor; and non-transitory computer-readable medium containing instruction that, when executed by the processor, causes the processor to perform: receiving by the educator module photos related to a number of activities and information regarding each one of the numbers of activities comprising one or more of: type or learning objective; date and location, list of participants; providing the media by a parental interface for parents' review; collecting key performance indicators (KPI) on the media using the parental module and reporting the KPI to the educator module; and using the KPI and at least one of: the type or learning objective, the date and location, the list of participants, to provide a selection from the media for at least one of the students.

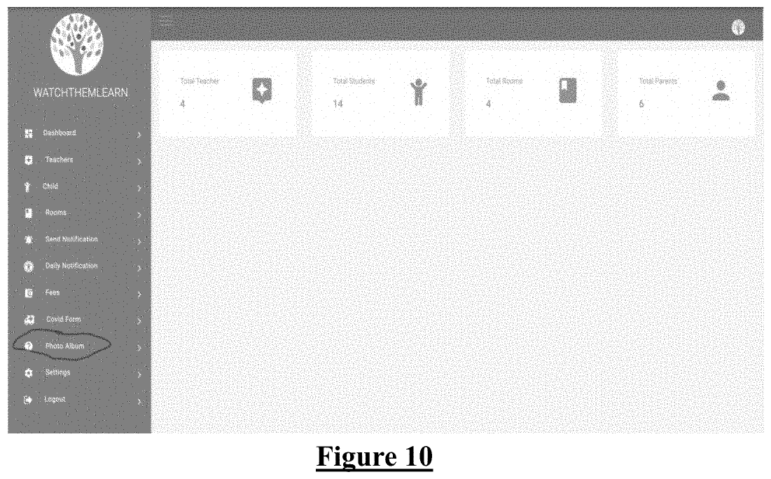

FIG. 10 shows an exemplary website used by a user access to the Photo Album through their Daycare Center's Admin Panel or interface 618 by login into the website and then clicking on the “Photo Album” function, as shown in FIG. 10, to access all the photos on their dashboard.

The administrator may then be able to create a photo album or even multiple albums by Theme and/or Special Event such as Field Trip(s), Graduation, Fundraising Event, Special Activity, etc. An album can be created by choosing a specific Classroom or the Entire Childcare Center.

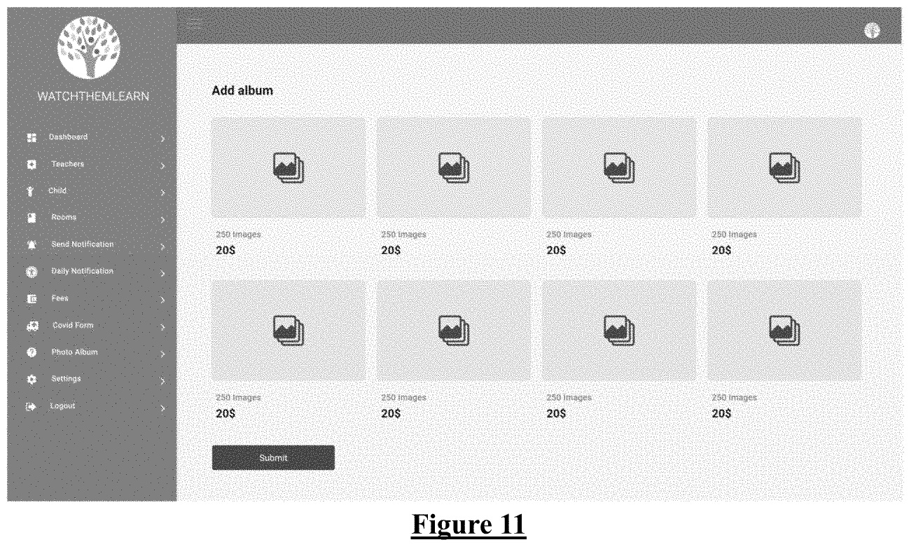

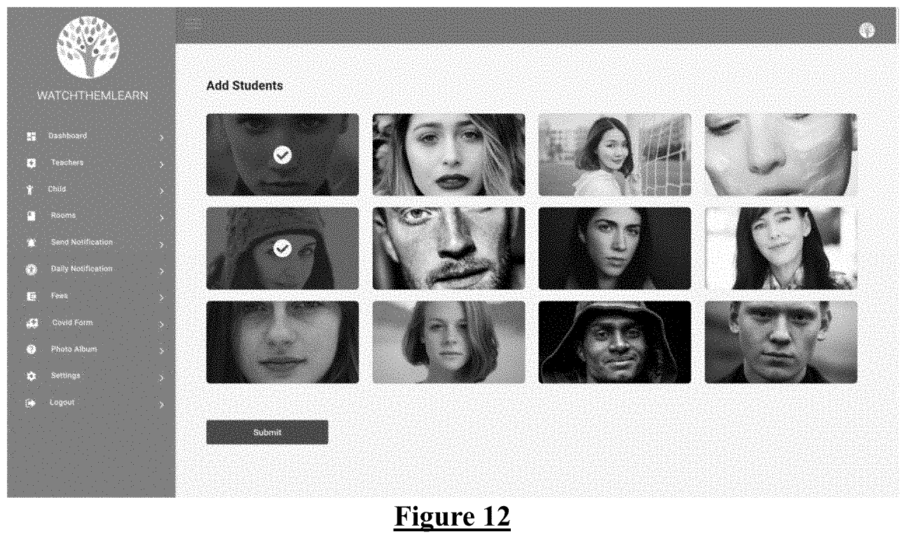

As shown in FIG. 11, once the photos are selected there will be a section where the parents will get to choose the size, design, price and how many albums they would like to print. Also, on the cover of the Photo Album the Childcare Center will be able to put their name and logo.

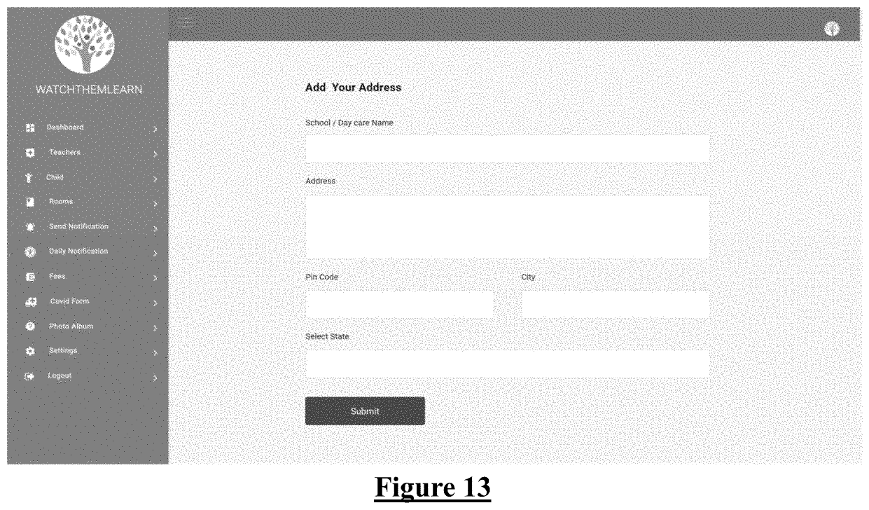

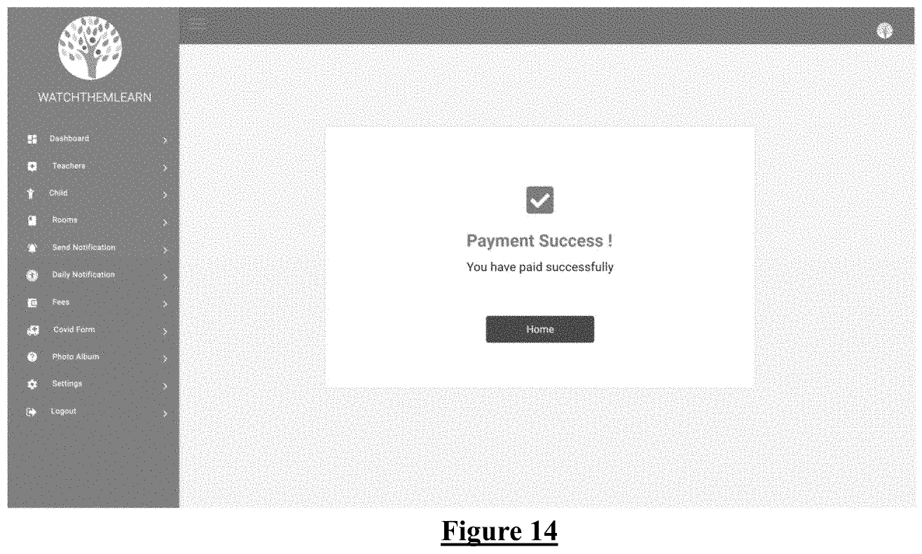

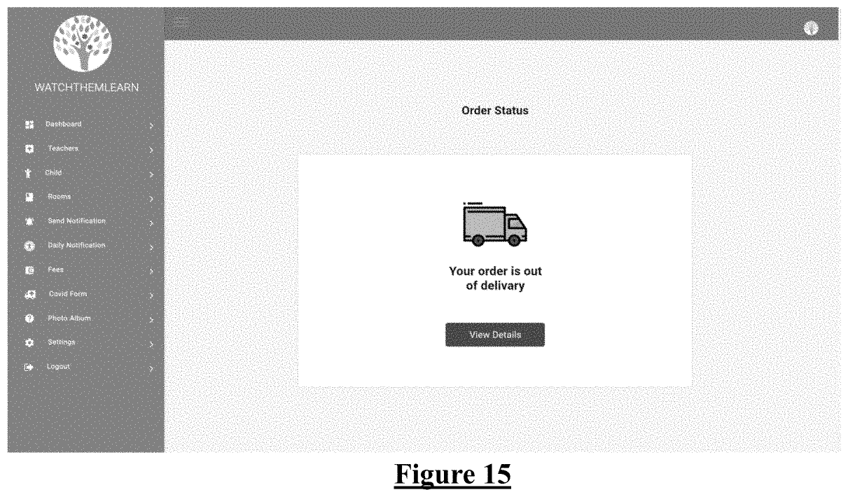

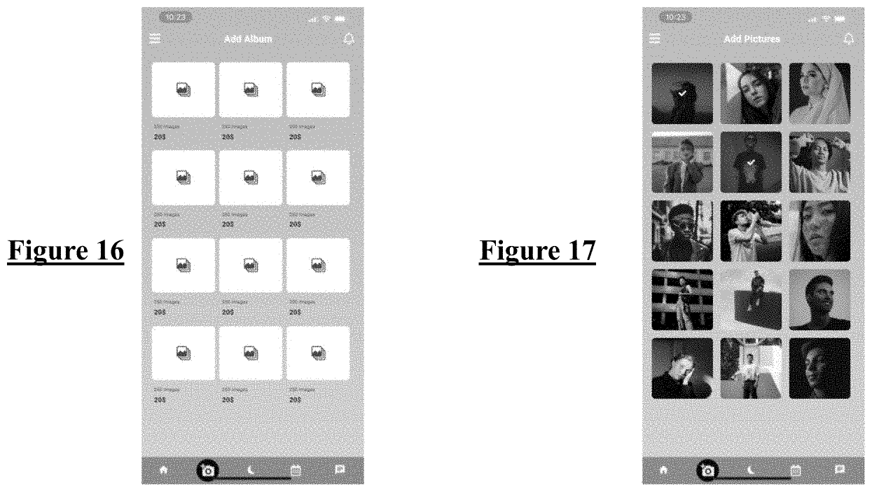

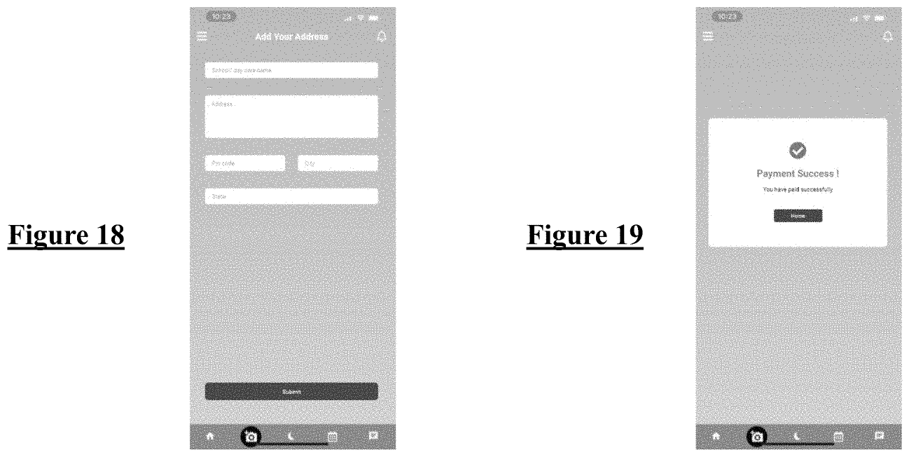

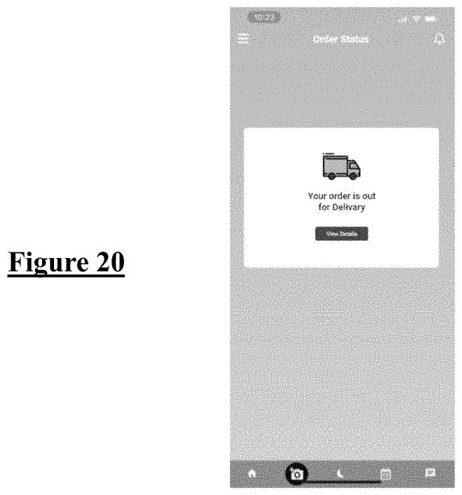

Parents can enter their postal address, as illustrated in FIG. 13, and complete the purchase by making the payment and tracking the delivery as shown in FIGS. 14 and 15. Similarly parents may use a mobile application, as shown in FIGS. 16 to 20, to choose an album, photos and complete the purchase.

In some examples of the present system, the parents may use an application to observe their child through video, pictures, messages, attendance, naptime, etc.

FIG. 21 is an exemplary embodiment of a common dashboard accessible by both the parent and educator interfaces. In this dashboard, the educator may create a post about the learning activity accomplished in a particular class. This learning activity may be part of a certain group of activities (such as ‘Math’ or ‘Science’, see FIG. 21 under ‘Umashankar’) and be identified as such. Educators and parents may have the ability to react to the posts with a number of reactions, comment on the posts, and perform other functions such as sharing the post. This function allows for parents to know exactly what activities were done at school and thus allow the parents to provide continuity to the education, such as by asking the students questions about the topics.

FIGS. 22-26 is an exemplary embodiment of some options that an educator may have when posting a new activity. In FIG. 22, the educator may have the ability to determine the group of activities from which the school activity completed in class is part of. In FIG. 23, once the group is chosen, the educator is given the option to choose one or many media listings. In FIG. 24, the educator may have the ability to add an image to complement the group and chosen activity, such as an image of the students doing the activity. FIGS. 22-24 may apply for an educator describing to parents what was done in class, but it may also apply to an educator choosing a media listing or activity that will be suggested to the parents. For example, the educator may make a post about an activity in the ‘Math’ group, which includes an activity about additional addition or subtraction exercises which the students can do at home with their parents. FIGS. 25 and 26 show that the app may be designed to give feedback to the educator that their file has successfully been uploaded.

FIGS. 27 and 28 show an educator interface receiving automatic feedback from the system about the engagement and interest of the parents and students about certain posted activities. In FIG. 27, the system has automatically synthesized information about which students or parents have liked the activity and is presenting that information to the educator. Such information may be useful for the educator in developing bonds with students (such as by asking the ones who liked an activity what they liked about it) or by planning classes more effectively (such as by focusing on topics that seem to garner much engagement from students). The system may also show the educator what kinds of reactions the activity has garnered (in the FIG. 27, all numbers are 25%). It should be understood that the system may provide the synthesized information in various ways not limited to what is shown in FIGS. 27-28. The educator may even have options to configure how they wish to receive information and KPIs about student performance or interest. In FIG. 28, the system may be configured to show the educator recommended activities based on the activity (such as related activities) or even take into account the KPIs about student performance or interest to determine which recommended activities may be most relevant to the educator.

Altogether, the system uses various strategies to keep educators appraised of what the students are doing and what they are interested in outside of school, and keep parents appraised of what students are doing inside of school. This allows for both parties to provide continuity to the education of the student by allowing both parties to engage with the student using the same topics or activities at home and at school, despite both parties potentially not interacting (as they may not have time, especially the educator may not have time to meet with each set of parents to discuss what has been done in class and what some recommended activities might be).

Although the present disclosure has been described with reference to preferred embodiments, it is to be understood that modifications may be resorted to as will be apparent to those skilled in the art. Such modifications and variations are to be considered within the purview and scope of the present invention.

Representative, non-limiting examples of the present disclosure were described above in detail with reference to the attached drawing. This detailed description is merely intended to teach a person of skill in the art further details for practicing preferred aspects of the present teachings and is not intended to limit the scope of the invention. Furthermore, each of the additional features and teachings disclosed above and below may be utilized separately or in conjunction with other features and teachings.

Moreover, combinations of features and steps disclosed in the above detailed description, as well as in the experimental examples, may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

What is claimed is:

1. A method for providing continuity of learning for early-age learners using a digital platform providing communication between educators and parents, the method comprising:
providing an educator interface;
providing a parent interface;
providing a server to which said educator interface and said parent interface can connect;
storing, in a database of said server, a list of activities that an educator may undertake with a pre-school class or group, and a media and/or product listing associated with each of said activities in said list;
connecting said educator interface to said database and using said educator interface to select a school activity from said list of activities, said selected school activity being completed during a day in pre-school for a class or group, and to select at least a portion of said media and/or product listing associated with said selected school activity;
transmitting to said parent interface associated with members of said class or group said selected school activity and said at least a portion of said media and/or product listing associated with said selected school activity;
receiving, from said parent interface of parents associated with said class or group, input representing appreciation of media on said listing and/or purchase decisions regarding one or products on said product listing;
preparing from said input received a dashboard view of said appreciation of said media and/or said purchase decisions and displaying said dashboard view using the educator interface.

2. The method of claim 1, further comprising, following viewing of said dashboard view, selecting a new school activity from said list of activities

3. The method of claim 1, wherein said dashboard view includes both a display of a listing of early-age learners participation in said media and/or said purchase decisions in addition to a rating or popularity of said media and/or said purchase decisions.

4. The method in claim 1, further comprising collecting photos or videos of said early-age learners corresponding to said school activity completed.

5. The method in claim 4 further comprising:
providing said photos or videos on said parental interface; and
receiving said feedback based on said photos and videos.

6. The method in claim 1, wherein said purchase decisions comprise a specification of delivery of said product to a school location associated with said educators.

7. A system for providing continuity of learning for early-age learners using a digital platform providing communication between educators and parents, the system comprising:
at least one processor; and
at least one non-transitory computer-readable medium containing instructions that, when executed by the processor, cause the at least one processor to perform:
storing, in a database of said server, a list of activities that an educator may undertake with a pre-school class or group, and a media and/or product listing associated with each of said activities in said list;
connecting said educator interface to said database and using said educator interface to select a school activity from said list of activities, said selected school activity being completed during a day in pre-school for a class or group, and to select at least a portion of said media and/or product listing associated with said selected school activity;
transmitting to said parent interface associated with members of said class or group said selected school activity and said at least a portion of said media and/or product listing associated with said selected school activity;
receiving, from said parent interface of parents associated with said class or group, input representing appreciation of media on said listing and/or purchase decisions regarding one or products on said product listing;
preparing, from said input received, a dashboard view of said appreciation of said media and/or said purchase decisions and displaying said dashboard view using the educator interface.

8. The system of claim 7, wherein said at least one non-transitory computer-readable medium contains instructions that, when executed by the processor, cause the at least one processor to further perform:
following viewing of said dashboard view, receiving a selection of a new school activity from said list of activities

9. The system of claim 7, wherein said at least one non-transitory computer-readable medium contains instructions that, when executed by the processor, cause the at least one processor to perform:
preparing, from said input received, said dashboard view to include both a display of a listing of early-age a a display of a listing of early-age learners participation in said media and/or said purchase decisions in addition to a rating or popularity of said media and/or said purchase decisions.
